(19) United States
(12) Patent Application Publication
(10) Pub. No.: US 2006/0194685 A1
(43) Pub. Date: Aug. 31, 2006

(54) Continuous centrifuge

(76) Inventor: Alexander Hamilton Lewis-Gray, Ballarat (AU)

Correspondence Address: KIRK HAHN, 14431 HOLT AVE, SANTA ANA, CA, 92705, US

(21) Appl. No.: 10/549,026

(22) PCT Filed: Mar. 17, 2003
(86) PCT No.: PCT/AU04/00265

§ 371 Date: Sep. 14, 2005

(30) Foreign Application Priority Data
Mar. 17, 2003 (AU) 2003901223

(51) Int. Cl. B04B 5/12

(52) U.S. Cl. 494/33; 494/63

(57) ABSTRACT

A centrifuge (1) for continuously separating a fluid stream into fractions of different density comprising:
conduit means (17) for radially directing flow of the fluid stream,
drive means (19, 22) for rotating the conduit means about an axis (19) whereby to subject the fluid stream to centrifugal force causing it to travel from a location in the conduit means nearer to the axis to a position further away from the axis, and
a plurality of conduit outlets (35, 36, 37) from the conduit means arranged at different radial distances from the axis for taking off fractions of different density from the fluid stream.

### FIELD OF THE INVENTION

This invention relates to a continuous centrifuge. It relates specifically but not exclusively to a continuous centrifuge which is capable of separating a plurality of fractions from a fluid stream and to methods for separating such fractions.

### BACKGROUND OF THE INVENTION

Centrifuges have long been used to separate fluids containing components having different densities. In one of the most common forms of centrifuge design, a fluid sealed in a container is rotated at high speed by a radial arm to generate a high degree of centripetal acceleration within the fluid. This centripetal acceleration accentuates the effect of differing densities in the fluid to cause the highest density components of the fluid to settle at a point radially outermost with the lower density components settling within the container in bands more radially inward.

Whilst such centrifuges are effective in providing separation of fluids into density layers, they suffer from a major disadvantage in that they require stop/start operation ie. each individual container needs to be filled and then attached to the centrifuge arm which initially must be stationary. The centrifuge is then speeded up from rest and operated until the various layers settle. It then needs to be stopped and the container holding the separated layers is removed. The layers are individually drained from the container. The whole process is repeated step by step until all the material required is separated.

Clearly this approach is inefficient both in terms of the handling involved and also in terms of the energy wasted in stopping and starting the centrifuge. It is also limited in relation to the rate at which material can be separated given the stop/start nature of the operation.

It is therefore an object of the invention to provide a centrifuge and method for operating same which ameliorates one or more of the aforesaid disadvantages of centrifuge designs.

### DISCLOSURE OF THE INVENTION

The invention provides in one aspect a centrifuge for continuously separating a fluid stream into fractions of different density comprising:

conduit means for radially directing flow of the fluid stream,

drive means for rotating the conduit means about an axis whereby to subject the fluid stream to centrifugal force causing it to travel from a location in the conduit means nearer to the axis to a position further away from the axis, and

a plurality of conduit outlets from the conduit means arranged at different radial distances from the axis for taking off fractions of different density from the fluid stream.

The conduit means may comprise two or more hollow arms. The hollow arms may be arranged so that the centrifugal force exerted by the arms is substantially balanced about the axis.

In a preferred aspect of the invention, there are two opposed arms. They may be in the form of pinch sluices.

The conduit outlets are suitably arranged in a wall of the conduit. They may be arranged at the bottom and/or side walls of the conduit. They may be adjusted in size so as to regulate the rate of discharge of a fraction of the fluid stream from the respective outlets. The conduit outlets may be arranged to discharge the fractions into a launder.

Suitably, the launder is provided with one or more baffles to define separate regions for receiving the individual discharges from the conduit outlets. The baffles may be concentric. The launder may also be provided with a sloping floor. Launder outlets may be arranged near a lower portion of the sloping floor. Individual launder outlets may be provided to correspond to each of the conduit outlets.

The fluid stream may be directed to the conduit means via a centrally located feed tube assembly. The feed tube assembly may incorporate a distribution chamber arranged to direct the fluid stream into arms of the conduit means.

The distribution chamber may direct the fluid stream at a region near the bottom surface of the pinch sluices comprising the conduit means.

Suitably the feed tube assembly includes one or more overflow tubes. The overflow tubes may direct overflow fluid stream into a central portion of the launder. The overflow fluid stream may be recycled to the centrifuge.

In another aspect the invention provides a method of continuously separating a fluid stream into fractions of different density comprising removing fractions of the fluid stream from a conduit means rotating about an axis, at varying distances away from the axis.

The invention also provides methods of separating fluid streams comprising subjecting the fluid streams to separation by centrifuges as hereinbefore defined.

Typical examples of fluid streams which may be separated using the centrifuge include slurries containing gold mineralisation, tantalum ores, tin ores, iron ores, coal, mineral sands, copper ores, silver, diamonds, zinc and lead. The invention may even be used for recycling operations such as the separation of plastic scrap from metal scrap. Needless to say, the range of fluids which may be separated is quite large and not limited to those specifically exemplified.

Preferred aspects of the invention will now be described with reference to the accompanying drawings.

### BRIEF DESCRIPTION OF THE DRAWINGS

FIG. 1 shows an isometric view of a centrifuge according to the invention;

FIG. 2 shows a plan view of the centrifuge of FIG. 1;

FIG. 3 shows an elevation taken through the vertical section A-A of FIG. 2;

FIG. 4 shows an enlarged view of a part of a feed tube assembly;

FIG. 5 shows a plan view of a section of conduit; and

FIG. 6 shows an elevation of the section of conduit of FIG. 5.

### DETAILED DESCRIPTION OF THE PREFERRED EMBODIMENT

The various elements identified by numerals in the drawings are listed in the following integer list.

### INTEGER LIST

1 Centrifuge
3 Launder assembly
5 Base frame assembly
7 Feed tube assembly
8 Inlet
9 Overflow tube
11 Flange
13 Flange
15 Distribution chamber
17 Conduit section/pinch sluice
19 Drive shaft
20 Bearing
22 Motor
23 Circular outer wall
24 Sloping floor
25 Concentric baffles
27 Outlet
28 Outlet
29 Outlet
30 Outlet
32 Flange
34 Inlet
35 Outlet
36 Outlet
37 Outlet
39 Mounting plate
40 Mounting plate
41 Mounting plate
42 Restriction orifice

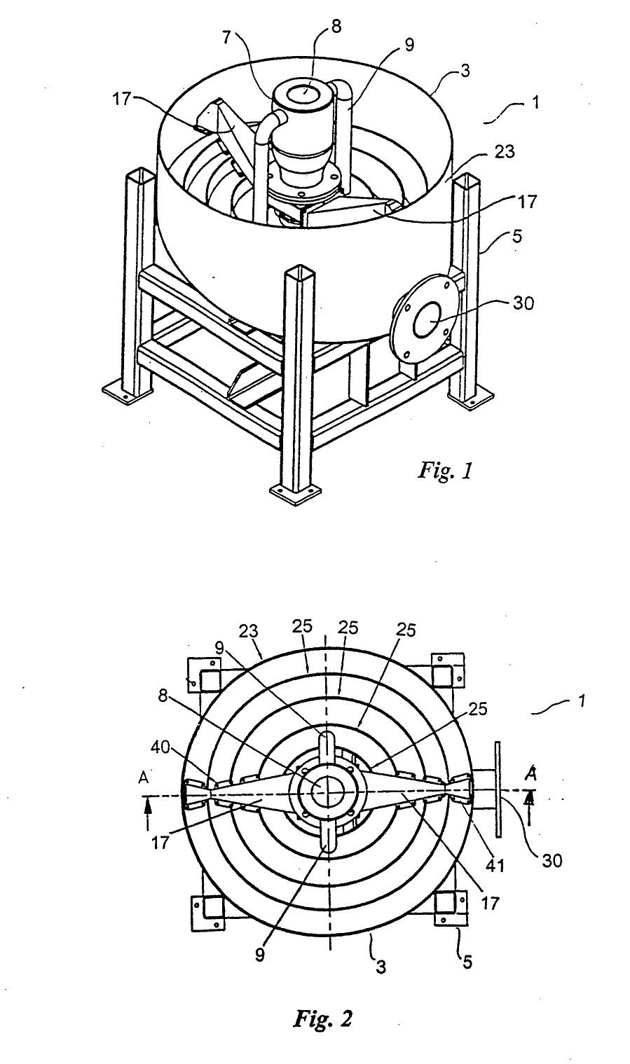

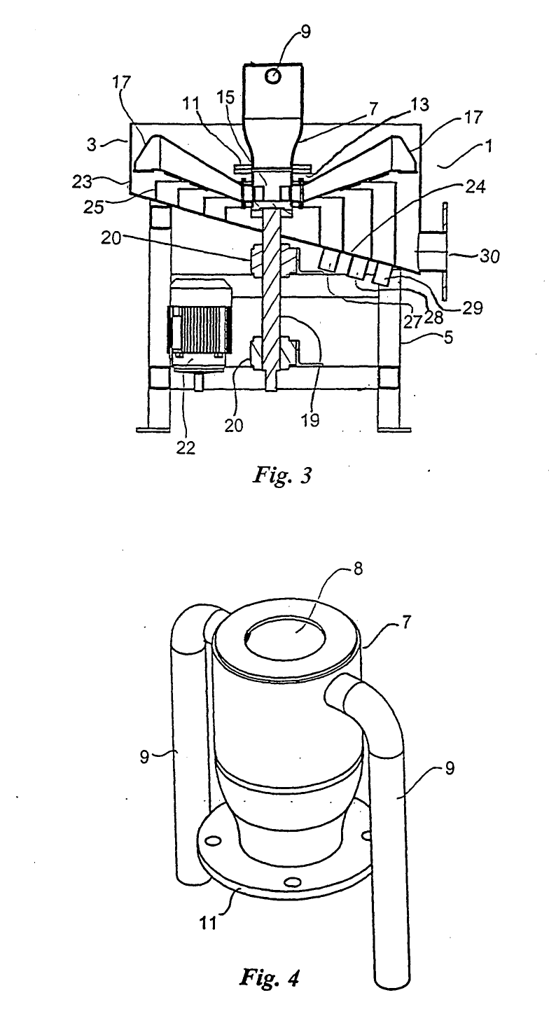

Referring to FIGS. 1 to 6 of the accompanying drawings, there is shown a centrifuge generally designated 1 for performing the invention.

The centrifuge comprises a launder assembly 3 mounted on a base frame assembly 5.

A rotatable feed tube assembly 7 is arranged centrally in the launder and includes an inlet 8 through which a fluid stream may be directed.

The feed tube assembly includes two overflow tubes 9 which are arranged to direct overflow fluid stream into a central portion of the launder. Flanges 11 and 13 are provided so as to facilitate joining of the distribution chamber 15 to the upper part of the feed tube assembly.

The distribution chamber is arranged so as to direct the fluid stream into the conduit sections 17 attached thereto. The conduit sections are in the form of pinch sluices in the illustrated embodiment. However other forms of conduits having a wide variety of shapes may be used depending upon the nature of the fluid stream. It is even possible to have a completely circular conduit extending around the distribution chamber.

A drive shaft 19 for rotating the feed tube assembly and attached conduit sections connects to the bottom of the distribution chamber 15. The drive shaft is mounted via the bearings 20 which in turn are mounted on the base frame assembly 5.

An electric motor 22 and associated conventional gearing/pulleys (not shown) rotates the drive shaft 19 and hence the feed tube assembly and associated conduit sections.

The launder assembly comprises a circular outer wall 23 attached to a sloping floor 24.

A number of concentric circular baffles 25 are provided so as to define a series of annular channels for receiving fluid stream directed from the conduit sections 17. Outlets 27, 28 and 29 are provided at a lower point on the sloping floor for tapping the separated fractions received in each of the annular channels.

A further outlet 30 is provided for the outer most of the annular channels.

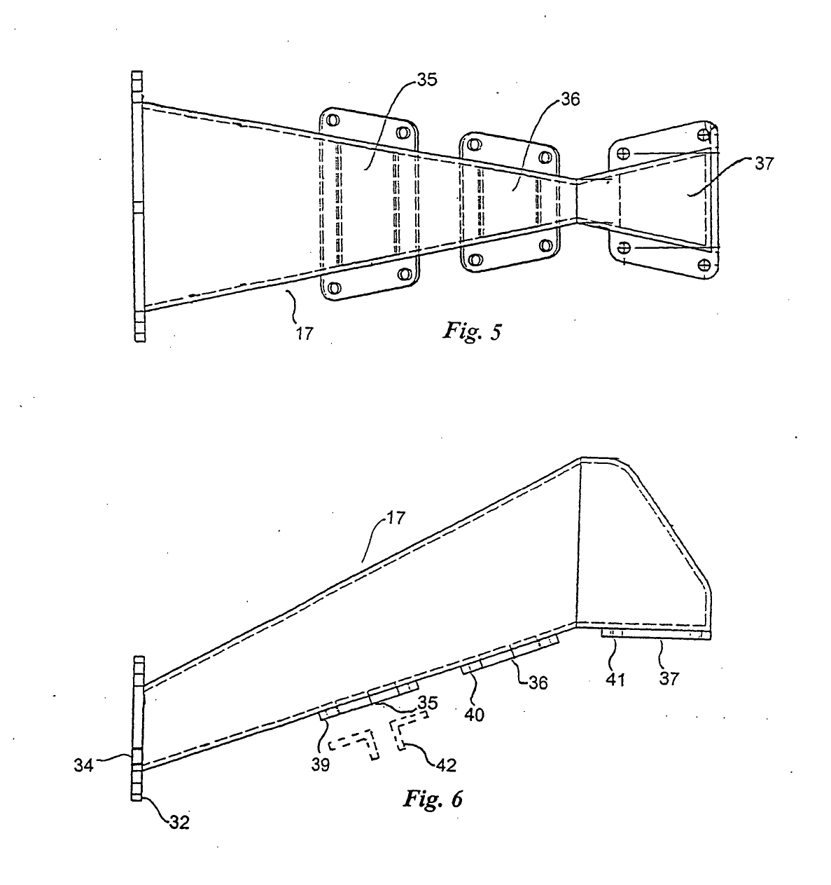

The conduit sections 17 shown in more detail in FIGS. 5 and 6 are in the form of pinch sluices. They include a flange 32 to facilitate attachment via a corresponding flange on the distribution chamber.

An inlet 32 is provided at a position proximate the floor of the pinch sluice so that the fluid stream enters into a position near the floor and is pushed upwardly as it moves radially outwardly along the pinch sluice. It is anticipated that an arrangement of inlet in this position should tend to have the effect of concentrating heavier materials near the base of the sluice. However, it is to be appreciated that the inlet may be arranged higher to get different effects in relation to the distribution of the different fractions as they move through the sluice.

The configuration of the pinch sluice, moving from a position radially inwardly to a position radially outwardly, begins with a broad but thinner conduit area tapering to a narrow but much thicker area radially outwardly therefrom to a location near its radially outermost point. From this position it again widens and reduces in thickness or depth as it approaches the radially outermost point.

A series of outlets 35, 36 and 37 are provided at radially different positions along the length of the pinch sluice. Whilst they are shown to be on the bottom surface of the pinch sluice in the drawings, it is to be appreciated that the openings may also or alternatively extend through the sides of the sluice depending upon the nature of the fluid stream and the type of separation required. Furthermore, whilst the drawings show the sides of the sluice as being formed of planar sheets, it is to be appreciated that the walls may be curved. Thus, if the outlets extend along the sides of the walls, it is to be anticipated that a more curved base/side wall arrangement may be used than the one shown in the drawings.

Mounting plates 39, 40 and 41 are provided immediately beneath each of the outlets 35, 36 and 37. These mounting plates are provided so as to allow restriction orifices of different sizes to be mounted thereon. An example of one form of restriction orifice 42 having an extended tube which protrudes below the level of the baffles 25 is shown in dotted outline separated from and below outlet 35 in FIG. 6. Thus, by choosing a particular size of restriction orifice, it is possible to regulate the amount of fluid stream tapped at each outlet. This in turn can have an effect on the nature of the fraction selected from the fluid stream.

The centrifuge can be operated continuously by feeding a constant stream of slurry into the inlet 8. The slurry passes into the distribution chamber 15 from whence the rotary motion of the distribution chamber and associated conduit sections 17 cause the slurry to be accelerated into and along the conduit section. A high rotation speed generates a high degree of centrifugal force to move the fluid stream. This has the effect of speeding separation of the different density components of the slurry. Different density fractions can be continuously expelled through the outlets 35, 36 and 37 into the concentric channels and hence out of the outlets 27, 28, 29 and 30 on a continuous basis.

Clearly, an apparatus and method in accordance with the invention can be operated continuously at a far greater rate than the stop and start processes hereinbefore described in relation to prior art devices.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A centrifuge for continuously separating a fluid stream into fractions of different density comprising:
conduit means for radially directing flow of the fluid stream,
drive means for rotating the conduit means about an axis whereby to subject the fluid stream to centrifugal force causing it to travel from a location in the conduit means nearer to the axis to a position further away from the axis, and
a plurality of conduit outlets from the conduit means arranged at different radial distances from the axis for taking off fractions of different density from the fluid stream.

2. The centrifuge of according to claim 1 wherein the conduit means comprise a plurality of hollow arms extending radially with respect to the axis so that the centrifugal force exerted by the arms is substantially balanced about the axis.

3. The centrifuge according to claim 2 wherein the conduit means comprise two pinch sluices.

4. The centrifuge according to claim 1 wherein the conduit outlets are adjustable to vary the rate of fluid flow therethrough.

5. The centrifuge according to claim 1 wherein the conduit outlets are arranged to discharge the fractions into a launder.

6. The centrifuge according to claim 5 wherein the launder is provided with at least one baffle to define separate regions for receiving discharges from the conduit outlets.

7. The centrifuge according to claim 6 wherein there is more than one baffle and the baffles are concentric.

8. The centrifuge according to claim 5 wherein the launder has a sloping floor.

9. The centrifuge according to claim 8 wherein the outlets from the launder are provided proximate the lower most level of the sloping floor and a separate launder outlet is provided to correspond to each conduit outlet.

10. The centrifuge according to claim 1 comprising a distribution chamber for directing the fluid stream into the conduit means the distribution chamber being located on the axis.

11. The centrifuge according to claim 10 wherein the conduit means comprise a pair of pinch sluices and the distribution chamber is arranged to direct the fluid stream into a region near the bottom of one end of the pinch sluices.

12. The centrifuge according to claim 1 comprising, a feed tube assembly including a distribution chamber for directing the fluid stream into the conduit means, and one or more overflow tubes for directing overflow fluid stream to a central portion of a launder located underneath the conduit means.

13. A method of continuously separating a fluid stream into fractions of different density comprising removing fractions of the fluid stream from conduit means rotating about an axis, at varying distances away from the axis by subjecting the fluid stream to separation by a centrifuge as defined in claim 1.

14-16. (canceled)
